(19) United States
(12) Patent Application Publication
(10) Pub. No.: US 2007/0179713 A1
(43) Pub. Date: Aug. 2, 2007

(54) System and method for optimizing seismic sensor response

(76) Inventor: Gary Lee Scott, Richmond, TX (US)

Correspondence Address: E. Eugene Thigpen;Petroleum Geo-Services, Inc., P.O. Box 42805, Houston, TX, 77242-2805, US

(21) Appl. No.: 11/346,101

(22) Filed: Feb. 2, 2006

(51) Int. Cl. G01V 1/28; G01D 18/00; G01V 1/00; G01C 19/00

(52) U.S. Cl. 702/14; 702/104

(57) ABSTRACT

A method for correcting response of a seismic sensor includes determining a response of the seismic sensor to a test signal. A response of a reference sensor to the test signal is also determined. The response of the seismic sensor to the test signal is adjusted to substantially match the response of the reference sensor to the test signal.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of seismic sensing devices. More particularly, the invention relates to systems and methods for correcting a response of seismic sensors for changes in the sensor response over time.

2. Background Art

Seismic sensors known in the art include various devices that generate electrical or optical signals in response to physical attributes such as motion, acceleration, pressure, time gradient of pressure and velocity. Seismic sensors are typically disposed on the Earth's surface in a selected pattern or array in land-based surveys, are towed behind a seismic vessel in an array of sensor “streamers” in marine seismic surveys, or are disposed on the bottom of a body of water in “ocean bottom cables.” All of the foregoing arrangements of sensors are to detect seismic energy that is reflected from subsurface Earth formation boundaries. The seismic energy is typically imparted by a seismic energy source disposed on or near the Earth's surface, or near the water surface, in the vicinity of the seismic sensors. Inferences about the structure and composition of the Earth's subsurface are made from recordings of the signals generated by the various seismic sensors.

In order to make the best possible inferences about the structure and composition of the Earth's subsurface from the signal recordings, it is desirable that the signals correspond as closely as possible to the actual value of the physical parameter being measured. To achieve this result, it is desirable to be able to evaluate the response of the various seismic sensors in order to determine whether a particular sensor should be removed from service and replaced. Methods and apparatus are known in the art for testing seismic sensors, such as geophones and hydrophones, in order to make such determination.

Generally, such methods and apparatus known in the art include actuating the seismic sensor by applying a test signal, such as an electrical pulse, to the seismic sensor. The test signal causes the sensor to undergo an electromechanical response. After the test signal is removed the sensor can return to its rest state. In returning to its rest state, the sensor will generate an electrical signal. For example, U.S. Pat. No. 4,754,438 issued to Erich, Jr. discloses an apparatus for obtaining a step function response signal from a seismic sensor known as a “geophone.” A geophone in its most general sense is a coil of electrical wire suspended in a magnetic field. Movement of the coil in the magnetic field induces a voltage in the coil related to the velocity at which the coil moves in the magnetic field. The apparatus disclosed in the Erich, Jr. '438 patent includes a controllable source of current, a means for producing a switching pulse, an electronic connecting means for applying current from the source to the geophone while the pulse is being produced, and an electronic connecting means for conducting the response signal from the geophone to a data acquisition system after the pulse has been produced. A time delay means is disclosed to delay the connecting of the signal to the data acquisition system for a time after the pulse is produced. The particular issue addressed by the Erich, Jr. '438 patent is that the geophone upon termination of the electrical test pulse initially generates a very large voltage, which may be difficult to characterize properly. The apparatus disclosed in the '438 patent provides electronic means to delay testing of the geophone response until such time as the response signal has decayed to a more useful amplitude.

Other seismic sensor test methods and apparatus are disclosed in U.S. Pat. No. 4,392,213 issued to Kung et al., which describes a system and method for using a step voltage or current signal for exciting geophones for testing purposes. A current signal is preferred because of the voltage drop in the long cables used to connect the geophones to the recording device, and the difficulty of providing the proper amplitude voltage signal to each individual geophone in an array of such geophones. The voltage or current pulse has a sufficient duration to move all of the geophone coils to an adjustable position short of their stop position. The current pulse is also sufficiently long to move all the geophones to their desired position to provide a “step” response. A step response is the response obtained when the current is effectively switched off (or on) substantially instantaneously. Such current switching provides more low frequency response information and is useful as a field quality check of the geophones and associated circuits. The voltage or current pulse is terminated and after a delay period the geophone step response is recorded. The delay period is sufficiently long to allow the back EMF induced in the geophone coil by the termination of the pulse to decay before the geophone response is recorded. In addition, steps are taken to ensure that the input to the recording system is shunted to ground during the switching operations so that no switch noise will be induced in the step response recording.

U.S. Pat. No. 4,043,175 issued to Fredricksson et al. discloses a geophone impulse-testing apparatus and method for detecting and digitally indicating selected amplitude indications of the damped motion of coils of one or more geophones undergoing testing after the coils, having been displaced and released from their displaced positions, undergo damped vibration. From the above-indicated value indications, geophone performance characteristics of interest, namely damping factor (b) and relative sensitivity (G), can be calculated.

In using the seismic sensor testing techniques known in the art, threshold criteria for the test response are typically established for the particular type of sensor being tested. If the response to the test signal indicates that the threshold criteria are not met for any one or more particular sensors, the particular sensors are removed from service and replaced in the array. It has been observed, however that seismic sensor response can undergo a gradual deterioration over time, during which the actual response of the seismic sensor to the signal being measured may be degraded, but to an insufficient degree to justify removing the particular seismic sensor from service. Such deterioration in response may provide signal recordings of less quality than that provided by more faithfully responsive sensors, which may lead to poorer quality inferences about the structure and composition of the Earth's subsurface. Moreover, such deterioration is to a great extent unpredictable, and therefore may affect the quality of some signal recordings while remaining undetected.

Even absent degradation of the sensor response over time, because seismic sensors have manufacturing tolerances, the actual response of any individual sensor may be different than the response of another sensor of the same type to exactly the same seismic energy input. To further the goal of making the best possible inferences concerning the Earth's subsurface, it is desirable that responses of seismic sensors to the physical parameter they measure is as close as practical to the response of an ideal sensor. An ideal sensor in the present context may be a sensor made within very precise tolerances to its optimum design specification, and not merely within manufacturing tolerances.

What is needed is a system for correcting the response of seismic sensors for minor changes, or variances from ideal, in response characteristics so that more faithful recordings of physical attributes of seismic energy can be made even with less than ideally responsive seismic sensors.

### SUMMARY OF THE INVENTION

One aspect of the invention is a method for correcting response of a seismic sensor. A method according to this aspect of the invention includes determining a response of the seismic sensor to a test signal. A response of a reference sensor to the test signal is also determined. The response of the seismic sensor to the test signal is adjusted to substantially match the response of the reference sensor to the test signal.

Another aspect of the invention is a seismic acquisition system. A seismic acquisition system according to this aspect of the invention includes at least one seismic sensor. A test signal generator is selectively coupled to the at least one seismic sensor. The system includes means for analyzing response of the at least one seismic sensor to a test signal conducted thereto by the test signal generator. The system includes means for comparing a response of the seismic sensor to the test signal to response of a reference sensor to a corresponding test signal.

Other aspects and advantages of the invention will be apparent from the following description and the appended claims.

### BRIEF DESCRIPTION OF THE DRAWINGS

FIG. 1 shows an example seismic data recording system than can be used with the invention.

FIG. 2 shows a data acquisition unit proximate a seismic sensor according to the invention.

FIG. 3 shows a flow chart of one embodiment of a method according to the invention.

### DETAILED DESCRIPTION

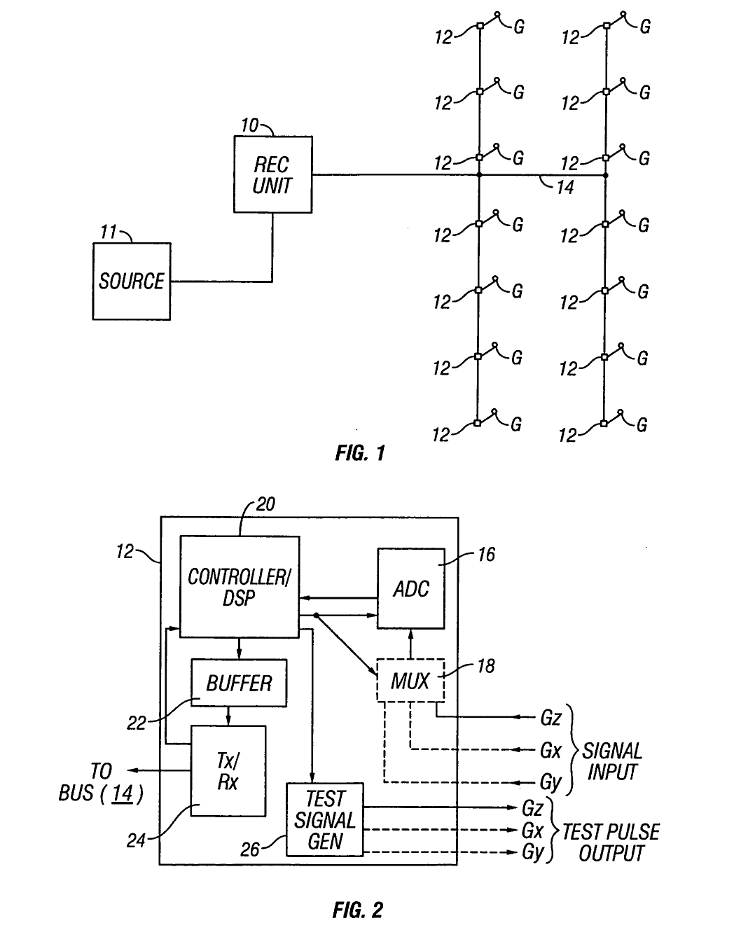

A typical seismic data acquisition system in which various embodiments of the invention may be used is shown schematically in FIG. 1. The seismic data acquisition system includes a recording unit, shown generally at 10, that typically has devices (not shown separately) for controlling actuation of a seismic energy source 11, such as a vibrator or dynamite, or air guns in the case of a marine seismic acquisition system, and for making time-indexed recordings of signals generated by each one of a plurality of seismic sensors, shown generally at G. The seismic sensors G in a land-based survey may be particle motion sensors, such as geophones, or other sensors responsive to motion and/or acceleration. The sensors G may be hydrophones in a marine survey, or combinations of hydrophones and geophones, particularly if the sensors are disposed in an ocean bottom cable on the water bottom. In the present embodiment, each sensor G can have associated therewith a signal processing and telemetry unit 12, which will be further explained with reference to FIG. 2.

During a seismic survey, the source control equipment in the recording unit 10 causes the seismic energy source 11 to actuate at selected times. The seismic sensors G detect seismic energy from the seismic energy source 11 that is reflected by various layer boundaries in the Earth's subsurface, and the sensors G generate electrical signals in response to the detected seismic energy. The electrical signals can be digitized in the signal processing and telemetry unit 12 associated with each sensor G, and can be stored therein until required to be included in a telemetry scheme for transmission along a signal bus 14 to the recording unit 10 for ultimate recording.

One embodiment of the signal processing and telemetry unit 12 is shown schematically in FIG. 2. The signal processing and telemetry unit 12 can include an analog to digital converter (“ADC”) 16. The ADC 16 converts analog electrical signals from the associated sensor (G in FIG. 1) into digital form. Preferably the ADC 16 makes digital samples of the sensor signal at a rate of at least twice the maximum frequency of the seismic energy to be detected by the seismic sensor G. To avoid digital undersampling and consequent signal aliasing of the signals from the seismic sensor G as a result of high frequency content in the detected seismic energy, it may be desirable to include an analog low-pass filter (not shown in FIG. 2) in some embodiments between the seismic sensor G and the input to the ADC 16. In some embodiments, the seismic sensor G may be a so-called “multi-component” seismic sensor. Multi-component seismic sensors can include three individual seismic sensors substantially collocated and oriented such that their sensitive axes are along mutually orthogonal directions. As shown in FIG. 2, such sensors can provide three signal outputs, denoted by Gx, Gy, Gz, where Gz represents by convention a signal corresponding to vertical motion, and Gx and Gy represent signals corresponding to horizontal motion in two orthogonal directions. Where such multi-component sensors are used, the individual component signals Gz, Gx, Gy may be coupled to the input of the ADC 16 through a multiplexer 18. Ocean bottom cable embodiments may also include a hydrophone (not shown) substantially collocated with the geophones, and an output of the hydrophone could be similarly digitized in the ADC 16 after the hydrophone signal is applied to the ADC 16 through the multiplexer 18.

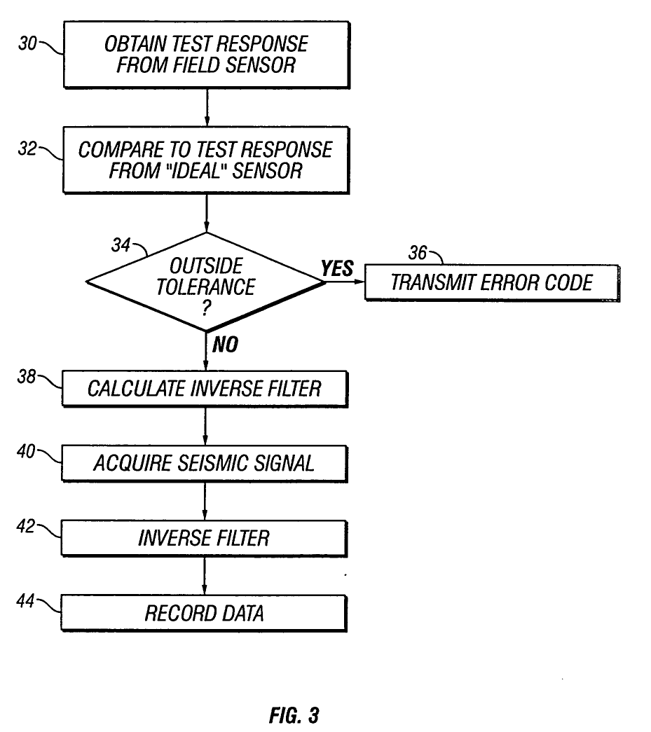

The digitized output of the ADC 16, which represents amplitude of the seismic sensor signal at discrete times, can be conducted to a controller/digital signal processor (“DSP”) shown at 20. The controller/DSP 20 may include a microprocessor based controller that can decode commands sent by the recording unit (10 in FIG. 1) over the bus 14 to operate the various components of the signal processing and telemetry unit 12. The controller/DSP 20 may include digital signal processing circuitry to calculate or determine various inverse filter or convolution operators, as well as to store certain reference signals for use as will be further explained with reference to FIG. 3. The generation of these various inverse filters and convolution operators is discussed further hereinafter. The inverse filter and/or convolution operators may be applied in the controller/DSP 20 to the signal samples output from the ADC 16. The inverse filtered and/or convolved digital samples may then be temporality stored in a buffer 22 until such time as they are transmitted by a telemetry transceiver 24 via bus 14 for ultimate recording in the recording unit (10 in FIG. 1).

During seismic signal acquisition, the recording unit (10 in FIG. 1) causes the seismic energy source (11 in FIG. 1) to actuate at selected times, as previously explained. The recording unit (10 in FIG. 1) may simultaneously send a command to the signal processing and telemetry units 12 over the bus 14 to begin digitizing signals generated by the associated sensor G (or component sensors Gz, Gx, Gy in multi-component sensors). Such command may be received in the transceiver 24 and communicated to the controller/DSP 20 which will then time index and process the digitized output of the ADC 16.

The present embodiment of the telemetry and signal processing unit 12 may also include a test signal generator 26 that can be selectively operated by the controller/DSP 20. The controller/DSP 20 may operate the test signal generator 26 periodically according to preset and/or programmable instructions in a resident program in the controller/DSP 20, upon command from the recording unit (10 in FIG. 1) or at other times at the discretion of the system designer or system user. The test signal generator 26 produces an electrical signal that is applied to the seismic sensor G, or all individual component sensors Gz, Gx, Gy in multi-component embodiments. The electrical test signal may be, for example, a switched direct current, alternating polarity direct current, or current switched or alternated in a sequence such as a pseudo-random binary sequence. The electrical test signal causes an electromechanical response in the seismic sensor G. During application of the test signal, the ADC 16 and multiplexer 18 may be temporarily inhibited to avoid having excessive amplitude signals applied thereto from the seismic sensor G, depending on the particular type and amplitude of the electrical test signal and on the type of sensor. When the electrical test signal is generated or at a selected time thereafter, the output of the sensor G may be digitized in the ADC 16 and conducted to the controller/DSP 20 for further processing.

In the present embodiment, the controller/DSP 20 may store a reference sensor response. The reference sensor response is the response to essentially the identical electrical test signal that would be produced, or actually was produced, by an “ideal” sensor. In one embodiment, the reference sensor response can be a numerically modeled response of a sensor. In other embodiments, the reference sensor response may be the actual, measured response of a physically embodied sensor made to very precise tolerances and examined for compliance with such tolerances. The controller/DSP 20 may include a signal processing routine to generate a matching function such as an inverse filter operator or a convolution operator, which when applied to the test signal response of the seismic sensor G will cause such response to substantially match the reference sensor response to an essentially identical test signal.

In some embodiments, the response of the reference sensor to the test signal may be the response of a type of sensor that is different from the seismic sensors in the acquisition system, and the matching function may be calculated to cause the response of the sensors in the acquisition system to substantially match such different type of reference sensor. For example, a reference sensor response of a hydrophone to the test signal may be measured for an “ideal” hydrophone, or may be modeled, just as in the previous embodiment. The sensors in the acquisition system may be geophones or accelerometers Thus, some embodiments may provide a process for causing the responses of sensors in the acquisition system (such as geophones, for example) to be matched to the response of a different type of sensor (such as a hydrophone, for example) to a test signal.

During seismic survey operations, each measured sample of seismic sensor response to the seismic energy generated by seismic energy source 11 and reflected from subsurface Earth formation boundaries can be digitized and transferred to the controller/DSP 20. The controller/DSP 20 can then apply a matching function, such as an inverse filter operator or a convolution operator, to the seismic sensor signals generated in response to the seismic energy. The signals that have been adjusted by the matching function as well as the unprocessed (although digitized) seismic sensor signals may be transferred to the buffer 22 for ultimate communication to the recording unit (10 in FIG. 1) and recording therein.

During use and handling of the acquisition system shown in FIG. 1, it may be expected that the response of the various seismic sensors G may degrade or be altered over time. In some embodiments, as each controller/DSP 20 in the system periodically conducts tests of the associated seismic sensor G by applying the test signal, the associated seismic sensor G response can be compared to the reference sensor response. A difference between the seismic sensor response and the reference sensor response may be determined, for example by calculating a difference between parameters from the respective responses such as amplitude, frequency, phase and bandwidth. If the difference between the reference sensor response and the seismic sensor response exceeds a selected threshold, the controller/DSP 20 may generate an indicator (or error signal) for transmission to the recording unit (10 in FIG. 1) that the particular sensor should be withdrawn from service. Alternatively, or additionally, the controller/DSP 20 may continue to calculate an adjusted response for the seismic sensor based on the most recently calculated matching function. In addition, in a system such as shown in FIG. 1, each controller/DSP can periodically test its associated seismic sensor and recalculate the matching function. By so doing, responses of all the seismic sensors in the system may be substantially matched to the reference sensor response at all times.

One embodiment of a method of using the system of FIGS. 1 and 2 will now be explained with reference to FIG. 3. At 30, a response of the reference sensor to the test signal is obtained, and is typically stored in the controller/DSP (20 in FIG. 2). At 32, the reference sensor response to the test signal is compared to the response of the seismic sensor under evaluation to the same test signal. At 34, if the difference, explained above, between the reference sensor response and the seismic sensor response exceeds a selected threshold or falls outside a predetermined tolerance, the controller/DSP 20 will generate an indication or send an error message to the recording unit (10 in FIG. 1), as shown at 36. If the difference is below the selected threshold or is within the predetermined tolerance, an inverse filter operator or convolution operator can be calculated, as shown at 38. The inverse filter operator or convolution operator, as previously explained, is a function which when applied to the response of the seismic sensor to the test signal will produce the response of the reference sensor to the test signal. During operation, signals from the sensor are then acquired, at 40, in response to seismic energy. The matching function or inverse filter operator, at 42 is then applied to the seismic sensor signals to produce corrected signals for recording at 44. The corrected signals may be recorded in addition to the uncorrected signals, or may be recorded alone. The corrected recorded signals may be used for interpretation of the structure and composition of the formations in the Earth's subsurface.

The foregoing system and method have been explained primarily in terms of a land-based seismic acquisition system, however the principles of the system and method are equally applicable to marine seismic acquisition systems. Further, while the foregoing embodiments are digital in architecture, it should be understood that analog implementations of a method and system are also possible and are within the scope of this invention. It should also be understood that association of a controller/DSP with each seismic sensor to perform the calculation of the matching function and subsequent seismic sensor signal adjustment is a matter of convenience for the system designer and is not intended to limit the scope of the invention. An embodiment in which the matching function is calculated at a single central location such as the recording unit (10 in FIG. 1) is also within the scope of this invention. Distributing the testing control, matching function calculation and application to be associated with each seismic sensor location may reduce the computational burden on the recording unit (10 in FIG. 1) and on the telemetry used in the bus (14 in FIG. 1).

A system and method according to the invention may provide more faithful recordings of seismic signals reflected from the Earth's subsurface and may provide more timely indication of malfunctioning seismic sensors.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method for correcting response of a seismic sensor, comprising:
determining a response of the seismic sensor to an electrical test signal;
determining a response of a reference sensor to the electrical test signal; the determining response of the reference sensor to the test signal comprising at least one of (i) applying electric current to a physically embodied sensor and switching off the electric current and measuring a voltage generated by the physically embodied sensor with respect to time, the embodies sensor made to predetermined tolerances and examined for conformance to the predetermined tolerances, and (ii) generating a numerical model of response of a sensor made to the predetermined tolerances;
adjusting the response of the seismic sensor to the electrical test signal to substantially match the response of the reference sensor to the electrical test signal; and
recording the adjusted response.

2. The method of claim 1 further comprising detecting seismic energy at the seismic sensor and using a matching function calculated to perform the adjusting to adjust response of the seismic sensor to the seismic energy.

3. The method of claim 2 wherein the matching function comprises an inverse filter.

4. The method of claim 1 further comprising generating an indicator when a difference between the determined response of the seismic sensor and the determined response of the reference sensor exceeds a selected threshold.

5. The method of claim 4 wherein the difference between the seismic sensor response and the reference sensor response comprises at least one of amplitude, frequency, phase and bandwidth.

6. The method of claim 1 wherein the determining response of the seismic sensor to the test signal comprises applying electric current to the seismic sensor, switching off the electric current, and measuring a voltage generated by the seismic sensor with respect to time.

7. (canceled)

8. (canceled)

9. The method of claim 1 further comprising repeating the determining the response of the seismic sensor to the test signal at selected times and repeating the adjusting to substantially match in respect of each act of repeating the determining response of the seismic sensor to the test signal.

10. The method of claim 9 further comprising at selected times actuating a seismic energy source, recording signals generated by the seismic sensor in response thereto and applying the matching function to the recorded signals.

11. The method of claim 1 wherein the reference sensor comprises a hydrophone and the seismic sensor comprises at least one of a geophone and an accelerometer.

12. The method of claim 1 further comprising:
determining a response of each of a plurality of seismic sensors to a test signal at a location proximate each seismic sensor;
determining a response of a reference sensor to the test signal;
adjusting the response of each seismic sensor to the test signal to substantially match the response of the reference sensor to the test signal at a location proximate each seismic sensor.

13. The method of claim 12 further comprising repeating the determining the response of each seismic sensor to the test signal at selected times and repeating the adjusting to substantially match in respect of each act of repeating the determining response of each seismic sensor to the test signal.

14. The method of claim 12 further comprising at selected times actuating a seismic energy source, recording signals generated by each seismic sensor in response thereto and applying the matching function to the recorded signals at each seismic sensor.

15. A seismic acquisition system, comprising:
at least one seismic sensor;
an electrical test signal generator selectively coupled to the at least one seismic sensor;
means for analyzing response of the at least one seismic sensor to an electrical test signal conducted thereto by the electrical test signal generator; and
means for comparing a response of the seismic sensor to the electrical test signal to response of a reference sensor to a corresponding electrical test signal the means for comparing response of the reference sensor to the test signal comprising at least one of (i) means for applying electric current to a physically embodied sensor made to predetermined tolerances and examined for conformance to the tolerances, means for switching off the electric current and means for measuring a voltage generated by the physically embodied sensor with respect to time, and (ii) means for at least one of generating and storing a numerical model of response of a sensor made to the predetermined tolerances;
means for adjusting the response of the at least one seismic sensor in response to the means for comparing; and
means for recording the adjusted response.

16. The system of claim 15 wherein the reference sensor response comprises a recording of response of a physically embodied sensor.

17. The system of claim 15 wherein the reference sensor response comprises a numerical model of a sensor response.

18. The system of claim 15 further comprising means for calculating a function which when applied to the response of the seismic sensor to the test signal will cause the response of the seismic sensor to the test signal to substantially match the reference sensor response to the test signal.

19. The system of claim 15 wherein the test signal generator comprises means for applying a switched electric current to the seismic sensor.

20. The system of claim 15 further comprising means for recording signals from the at least one seismic sensor in response to seismic energy, the means for recording including means for adjusting the recorded signals to substantially match signals that would be generated by the reference sensor in response to the seismic energy.

21. The system of claim 20 further comprising a plurality of spatially distributed seismic sensors, each seismic sensor including a respective test signal generator, a respective means for analyzing, a respective means for comparing and a respective means for recording.

22. The system of claim 15 wherein the response of the reference sensor comprises response of a hydrophone to the test signal, and wherein the seismic sensor comprises one of a geophone and an accelerometer.
